(19) United States
(12) Patent Application Publication
(10) Pub. No.: US 2021/0185595 A1
(43) Pub. Date: Jun. 17, 2021

(54) METHOD AND APPARATUS FOR INDICATING AND DETERMINING TRANSMISSION DIRECTION OF TRANSMISSION UNIT

(71) Applicant: BEIJING XIAOMI MOBILE SOFTWARE CO., LTD., Beijing (CN)

(72) Inventor: Yajun ZHU, Beijing (CN)

(73) Assignee: BEIJING XIAOMI MOBILE SOFTWARE CO., LTD., Beijing (CN)

(21) Appl. No.: 17/184,322

(22) Filed: Feb. 24, 2021

Related U.S. Application Data
(63) Continuation of application No. PCT/CN2018/103354, filed on Aug. 30, 2018.

(51) Int. Cl. H04W 48/12; H04W 16/14

(52) U.S. Cl. CPC H04W 48/12; H04W 16/14

(57) ABSTRACT

A method and an apparatus can be employed for indicating and determining a transmission direction of a transmission unit. A base station can occupy unauthorized channel resource, and send information corresponding to the transmission direction of the transmission unit within a predefined time window to a terminal on one available transmission unit after occupying the unauthorized channel resource. The terminal can receive the information, and determine the transmission direction of the transmission unit within the predefined time window according to the information.

### CROSS-REFERENCE TO RELATED APPLICATIONS

This application is a continuation application of International Application No. PCT/CN2018/103354 filed on Aug. 30, 2018, the disclosure of which is hereby incorporated by reference in its entirety.

### BACKGROUND

During the development of wireless communication systems, for unauthorized frequency bands, in the 3GPP (3rd Generation Partnership Project), a LAA (License Assisted Access) mechanism is proposed to use the unauthorized frequency bands. That is, the use of unauthorized frequency bands is realized with assistance of authorized frequency bands. In order to ensure the coexistence with other systems such as Wi-Fi on unlicensed frequency bands, LBT (Listen Before Talk) is also introduced in LAA. The transmitting terminal needs to check whether the channel is idle when there is data to be sent, and the transmitting terminal can only send data when the channel is idle. The time that the transmitting terminal can use the channel is limited by MCOT (Maximum Channel Occupancy Time). That is, after the transmitting terminal carries out one channel detection procedure and successfully obtains the channel, the maximum channel occupancy time cannot exceed the time defined by MCOT.

### SUMMARY

The present disclosure relates to a field of communication technology, and particularly to a method and an apparatus for indicating and determining a transmission direction of a transmission unit, and a storage medium.

According to a first aspect of the present disclosure, a method for indicating a transmission direction of a transmission unit is provided. The method is applied to a network side device, and includes: occupying unlicensed band resource; sending information corresponding to a transmission direction of a transmission unit within a predefined time window to a terminal on one available transmission unit after occupying the unlicensed band resource.

According to a second aspect of the present disclosure, a method for determining a transmission direction of a transmission unit is provided. The method is applied to a terminal and includes: receiving information corresponding to a transmission direction of a transmission unit within a predefined time window sent by a network side device, wherein the information is sent by the network side device on one available transmission unit after occupying unlicensed band resource; determining the transmission direction of the transmission unit within the predefined time window according to the information.

According to a third aspect of the present disclosure, an apparatus for indicating a transmission direction of a transmission unit is provided. The apparatus includes: a processor; a memory configured to store instructions executable by the processor. The processor is configured to: occupy unlicensed band resource; send information corresponding to a transmission direction of a transmission unit within a predefined time window to a terminal on one available transmission unit after the unlicensed band resource is occupied.

According to a fourth aspect of the present disclosure, a non-temporary computer-readable storage medium is provided. When instructions in the storage medium are executed by a processor, the processor is enabled to implement the method described in the first aspect of the present disclosure.

According to a fifth aspect of the present disclosure, an apparatus for determining a transmission direction of a transmission unit is provided. The apparatus includes: a processor; a memory configured to store instructions executable by the processor. The processor is configured to: receive information corresponding to a transmission direction of a transmission unit within a predefined time window sent by a network side device, wherein the information is sent by the network side device on one available transmission unit after occupying unlicensed band resource; determine the transmission direction of the transmission unit within the predefined time window according to the information.

According to a sixth aspect of the present disclosure, a non-temporary computer-readable storage medium is provided. When instructions in the storage medium are executed by a processor, the processor is enabled to implement the method described in the second aspect of the present disclosure.

It should be understood that, the above general description and the following detailed description are only exemplary and explanatory, and cannot limit the present disclosure.

### BRIEF DESCRIPTION OF THE DRAWINGS

The drawings herein are incorporated into the specification and constitute a part of the specification, show embodiments in conformity with embodiments of the present disclosure, and explain the principle of the present disclosure together with the specification.

FIG. 1 is a flowchart illustrating a method for indicating a transmission direction of a transmission unit according to an example embodiment.

FIG. 2 is a schematic diagram illustrating slots of MCOT according to an example embodiment.

FIG. 3 is a flowchart illustrating a method for indicating a transmission direction of a transmission unit according to an example embodiment.

FIG. 4 is a flowchart illustrating a method for indicating a transmission direction of a transmission unit according to an example embodiment.

FIG. 5 is a flowchart illustrating a method for indicating a transmission direction of a transmission unit according to an example embodiment.

FIG. 6 is a flowchart illustrating a method for determining a transmission direction of a transmission unit according to an example embodiment.

FIG. 7 is a flowchart illustrating a method for determining a transmission direction of a transmission unit according to an example embodiment.

FIG. 8 is a flowchart illustrating a method for determining a transmission direction of a transmission unit according to an example embodiment.

FIG. 9 is a flowchart illustrating a method for determining a transmission direction of a transmission unit according to an example embodiment.

FIG. 10 is a block diagram illustrating an apparatus for indicating a transmission direction of a transmission unit according to an example embodiment.

FIG. 11 is a block diagram illustrating an apparatus for indicating a transmission direction of a transmission unit according to an example embodiment.

FIG. 12 is a block diagram illustrating an apparatus for indicating a transmission direction of a transmission unit according to an example embodiment.

FIG. 13 is a block diagram illustrating an apparatus for indicating a transmission direction of a transmission unit according to an example embodiment.

FIG. 14 is a block diagram illustrating an apparatus for determining a transmission direction of a transmission unit according to an example embodiment.

FIG. 15 is a block diagram illustrating an apparatus for indicating a transmission direction of a transmission unit according to an example embodiment.

FIG. 16 is a block diagram illustrating an apparatus for determining a transmission direction of a transmission unit according to an example embodiment.

FIG. 17 is a block diagram illustrating an apparatus for determining a transmission direction of a transmission unit according to an example embodiment.

FIG. 18 is a block diagram illustrating a device for determining a transmission direction of a transmission unit according to an example embodiment.

FIG. 19 is a block diagram illustrating an apparatus for indicating a transmission direction of a transmission unit according to an example embodiment.

### DETAILED DESCRIPTION

The exemplary embodiments will be described in detail here, and examples are shown in the appended drawings. When the following descriptions refer to the accompanying drawings, unless otherwise indicated, the same numbers in different drawings represent the same or similar elements. The implementations described in the following example embodiments do not represent all the implementations consistent with the present invention. Rather, they are merely examples of the apparatus and method consistent with some aspects of the present invention as detailed in the appended claims.

In the LTE system, according to differences of duplex modes, there are two operation modes: FDD (Frequency Division Duplexing) and TDD (Time Division Duplexing). For FDD mode, uplink and downlink transmissions are implemented on different carrier waves. For TDD mode, uplink and downlink transmissions are implemented on the same carrier wave. The terminal implements the uplink and downlink transmission using one configuration based on the notification of the base station.

In another wireless cellular communication system 5G NR (New Radio), it also supports dynamically indicating the transmission direction information of the transmission unit through the physical layer signaling SFI (Slot Format Indicator). The base station configures information such as the period and location of the terminal detecting the SFI through a higher layer, and the terminal obtains the information indicating the transmission direction of the transmission unit by detecting the SFI at the corresponding position.

In the current way of dynamically indicating the transmission direction of the transmission unit, the terminal needs to detect the SFI information at the pre-configured detection period and location. However, since the cellular communication system working on the unauthorized frequency band need to compete with other communication systems to use channel resources, the base station may fail to occupy the channel at the preset position for sending the SFI, and fail to send the information indicating transmission direction of the transmission unit.

As for the way to send SFI on each transmission unit, the terminal needs to detect SFI information on each transmission unit, which will result in relatively large detection overhead for the terminal.

The MCOT involved in this disclosure is configured to limit the time the data transmitting terminal uses the channel. That is, after the transmitting terminal carries out one channel detection procedure and successfully acquires the channel, the maximum channel occupancy time cannot exceed the time defined by MCOT.

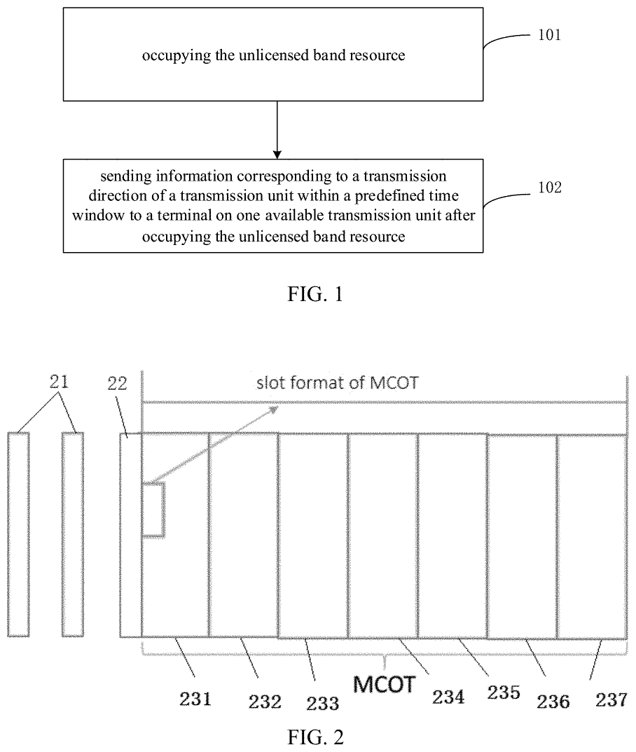

FIG. 1 is a flowchart illustrating a method for indicating a transmission direction of a transmission unit according to an example embodiment. The method can be applied to a network side device, such as a base station. As illustrated in FIG. 1, the method includes the following blocks.

In block 101, unlicensed band resource is occupied.

In block 102, information corresponding to a transmission direction of a transmission unit within a predefined time window is sent to a terminal on one available transmission unit after the unlicensed band resource is occupied. The one available transmission unit may be the first transmission unit within the predefined time window or other transmission unit within the predefined time window. When the available transmission unit is the first transmission unit within the predefined time window, the time for the terminal to obtain the information corresponding to the transmission direction of the transmission unit can be further shorten.

One transmission unit may be one slot, one symbol, one sub-frame, one radio frame or other transmission unit in time domain.

In a possible implementation, the above predefined time window may be one MCOT. FIG. 2 is a schematic diagram of MCOT according to an example embodiment. In FIG. 2, the transmission unit takes slot as an example. 21 indicates the failure of the LBT, while 22 indicates the success of the LBT. After the success of LBT, i.e. the network side device successfully occupies the unlicensed band resource, 231 indicates the first slot after the network side device successfully occupies the unlicensed band resource and 232-237 are respectively other slots in the MCOT.

In a possible implementation, the information corresponding to the transmission direction of the transmission unit within the predefined time window is sent to the terminal at a preset time frequency position of one available transmission unit after occupying the unlicensed band resource. The preset time frequency position may be notified to the terminal in advance by the network side device, or may be agreed in advance between the network side device and the terminal.

In a possible implementation, the network side device may send the information corresponding to the transmission direction of the transmission unit within the predefined time window to the terminal on one available transmission unit described above.

In a possible implementation, the information corresponding to the transmission direction of the transmission unit within the predefined time window may include, for example, indication information of the transmission direction of the transmission unit within the predefined time window, and the indication information may be configured to indicate the transmission direction of the transmission unit, while in another possible implementation, the information corresponding to transmission direction of the transmission unit within the predefined time window may include, for example, configuration information for instructing the terminal to detect the indication information of the transmission direction of the transmission unit on the unlicensed band resource. The configuration information is hereinafter referred to as the detection configuration information for short.

With the method for indicating the transmission direction of the transmission unit provided by the embodiments of the present disclosure, the information corresponding to transmission direction of the transmission unit within the predefined time window is sent to the terminal on one available transmission unit after the unlicensed band resource is occupied by the network side device, which ensures that when the network side device successfully occupies the channel resource, the information corresponding to transmission direction of the transmission unit within the predefined time window can be sent to the terminal through this channel resource as soon as possible, so that the terminal device can obtain the information of the transmission direction as soon as possible.

In a possible implementation, the information corresponding to the transmission direction of the transmission unit may include at least one of uplink, downlink, or unknown, and the indication information may also include respective identifications of transmission units, and each identification may correspond to the transmission direction of the transmission unit identified. For example, the transmission direction corresponding to the identification 1 is uplink, which means the transmission direction of the transmission unit identified by the identification 1 is uplink, and the transmission direction corresponding to the identification 2 is downlink, which means the transmission direction of the transmission unit identified by the identification 2 is downlink, and the transmission direction corresponding to the identification 3 is unknown, which means the transmission direction of the transmission unit identified by the identification 3 is unknown.

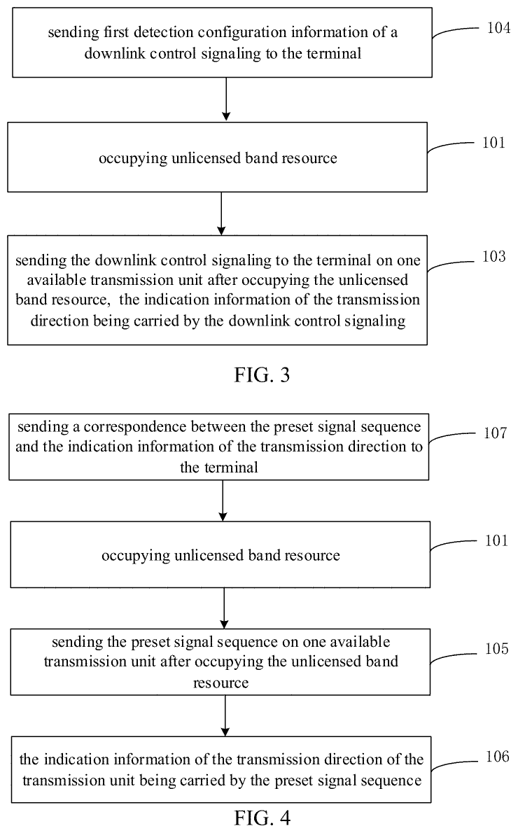

FIG. 3 is a flowchart illustrating a method for indicating a transmission direction of a transmission unit according to an example embodiment. As illustrated in FIG. 3, in this method, sending information corresponding to the transmission direction of the transmission unit within the predefined time window to the terminal on one available transmission unit after the unlicensed band resource is occupied may include: in block 103, sending a downlink control signaling to the terminal on one available transmission unit after the unlicensed band resource is occupied, the indication information of the transmission direction being carried by the downlink control signaling. The terminal may detect the downlink control signaling on the unlicensed band, and acquire the transmission direction of each transmission unit within the predefined time window based on the indication information of the transmission direction of the transmission unit carried by the downlink signaling, thereby saving the overhead for the terminal to detect the downlink control signaling.

In a possible implementation, in order to reduce the complexity for the terminal to detect the downlink control signaling carrying the indication information of the transmission direction of the transmission unit, the network side device may send the detection configuration information of the downlink control signaling to the terminal through predefining or by sending a signaling to the terminal.

As illustrated in FIG. 3, based on the method shown in FIG. 1, this method may further include: in block 104, sending first detection configuration information of the downlink control signaling to the terminal. The first detection configuration information includes at least one of the following information: the aggregation level of the downlink control signaling, the information length of the downlink control signaling, the position of the downlink control signaling on the unlicensed band resource, and the number of times to detect the downlink control signaling. Block 104 may be executed before or after block 101.

FIG. 3 only shows a case where block 104 is executed before block 101. In this embodiment, the information length of the downlink control signaling may be fixed or variable. When the information length of the downlink control signaling is variable, the base station may flexibly adjust the information length of the downlink control signaling according to the number of transmission units within the predefined time window.

In a possible implementation, the information corresponding to the transmission direction of the transmission unit may include indication information of the transmission direction, and the indication information of the transmission direction may include at least one of uplink, downlink, or unknown.

FIG. 4 is a flowchart illustrating a method for indicating a transmission direction of a transmission unit according to an example embodiment. sending the information corresponding to the transmission direction of the transmission unit to the terminal on one available transmission unit after occupying the unlicensed band resource may include: in block 105, sending a preset signal sequence on one available transmission unit after occupying the unlicensed band resource; in block 106, carrying the indication information of the transmission direction of the transmission unit on the preset signal sequence. The preset signal sequence is, for example, a character sequence composed of letters and/or numbers. For example, one character sequence may uniquely identify one of uplink, downlink, and unknown transmission directions. When the terminal learns in advance the correspondence between the preset signal sequence and the indication information of the transmission direction of the transmission unit, the terminal may obtain the transmission direction of the transmission unit after learning the preset signal sequence, thereby saving the overhead for the terminal to detect the downlink control signaling.

In a possible implementation, as illustrated in FIG. 4, the method for indicating the transmission direction of the transmission unit may further include: in block 107, sending the correspondence between the preset signal sequence and the indication information of the transmission direction to the terminal. For example, the network side device and the terminal may agree on the correspondence between the preset signal sequence and the indication information of the transmission information of the transmission unit in advance, or the network side device may notify the terminal in advance of the correspondence between the preset signal sequence and the indication information of the transmission direction of the transmission unit. The network side device may send a preset signal on a preset time-frequency resource on one available transmission unit. The preset signal may carry indication information of the transmission direction of the transmission units within the entire predefined time window. Before this, the network side device may also pre-define or send the correspondence between the preset signal sequence and the direction indication information through signaling. The network side device may select the corresponding preset signal sequence and send it on the preset time domain resource based on the indication information of the transmission direction of the transmission unit within the predefined time window. After the terminal detects the preset signal sequence, the terminal may obtain the indication information of the transmission direction of the transmission unit within the predefined time window by comparing the preset signal sequence with the correspondence between the preset signal sequence and direction indication information that is pre-defined or that the base station notifies the terminal through signaling, thereby saving the overhead for the terminal to detect the downlink control signaling. Block 107 may be executed before block 101 or after block 101. FIG. 4 only shows a case where block 107 is executed before block 101.

In a possible implementation, the information corresponding to the transmission direction of the transmission unit may include second detection configuration information, and the second detection configuration information may be configured to instruct the terminal to detect the indication information of the transmission direction of the transmission unit on the unlicensed band resource.

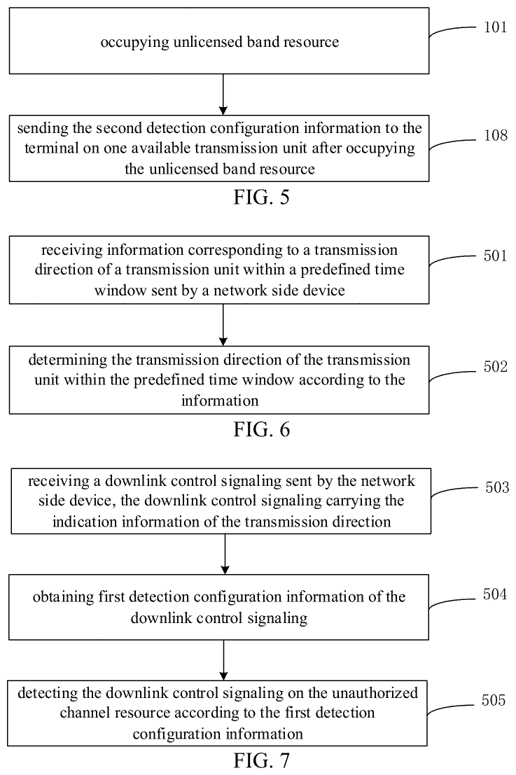

FIG. 5 is a flowchart illustrating a method for indicating a transmission direction of a transmission unit according to an example embodiment. As illustrated in FIG. 5, in this method, sending the information corresponding to the transmission direction of the transmission unit within the predefined time window to the terminal on one available transmission unit after occupying the unlicensed band resource may include: in block 108, sending the second detection configuration information to the terminal on one available transmission unit after occupying the unlicensed band resource. For example, the network side device sends the detection configuration information indicating the transmission direction information of the transmission unit on the preset time-frequency resource on one available transmission unit after successfully occupying the unlicensed band. The detection configuration information may include information indicating how the terminal to detect the transmission direction of the transmission unit. Based on the detection configuration information, the terminal may detect the indication information of the transmission direction of the transmission unit at the corresponding position on the unlicensed band resource, thereby saving the overhead for the terminal to detect the downlink control signaling.

In a possible implementation, based on the method in FIG. 5, when the indication information of the transmission direction of the transmission unit is carried by the downlink control signaling, the second detection configuration information may include at least one of the following information: the aggregation level of downlink control signaling, the information length of the downlink control signaling, the position of the downlink control signaling on the unlicensed band resource, and the number of times to detect the downlink control signaling. After receiving the second detection configuration information sent by the network side device, the terminal may detect the indication information of the transmission direction of the transmission unit on the unlicensed band resource according to at least one information included in the information, so as to learn the transmission direction of the transmission unit according to the indication information of the transmission unit detected, thereby saving the overhead for the terminal to detect the downlink control signaling. The network side device may send the detection configuration information of the downlink control signaling to the terminal through predefining or through signaling.

In a possible implementation, based on the method in FIG. 5, when the indication information of the transmission direction is carried by a preset signal sequence, the second detection configuration information may include the period for detecting the preset signal sequence and/or the position of the preset signal sequence in the unlicensed band resource. After receiving the second detection configuration information sent by the network side device, the terminal may detect the indication information of the transmission direction of the transmission unit on the unlicensed band resource based on the period of the preset signal sequence and/or the position of the preset signal sequence in the unlicensed band resource included in the information. The terminal may obtain the transmission direction of the transmission unit according to the indication information detected and the correspondence between the preset signal sequence and the indication information of the transmission direction of the transmission unit, thereby saving the overhead for the terminal to detect the downlink control signaling.

FIG. 6 is a flowchart illustrating a method for determining a transmission direction of a transmission unit according to an example embodiment. The method may be applied to a terminal. As illustrated in FIG. 6, the method includes the following blocks.

In block 501, information corresponding to a transmission direction of a transmission unit within a predefined time window sent by a network side device is received. The information is sent by the network side device on one available transmission unit after occupying the unlicensed band resource.

In a possible implementation, the network side device may send the information corresponding to the transmission direction of the transmission unit within the predefined time window to the terminal at a preset time-frequency position of one available transmission unit after occupying the unlicensed band resource. The preset time-frequency position may be notified to the terminal in advance by the base station, or may be agreed in advance by the base station and the terminal.

The predefined time window may be one MCOT.

In a possible implementation, the terminal receives the information corresponding to the transmission directions of all the transmission units within the predefined time window sent by the network side device.

In block 502, the transmission direction of the transmission unit within the predefined time window is determined according to the information.

In a possible implementation, the information corresponding to the transmission direction of the transmission unit within the predefined time window may include, for example, indication information of the transmission direction of the transmission unit within the predefined time window. The indication information may be configured to indicate the transmission direction of the transmission unit. After acquiring the indication information, the terminal may learn the transmission direction of the transmission unit. In another possible implementation, the information corresponding to the transmission direction of the transmission unit within the predefined time window may include, for example, the configuration information for instructing the terminal to detect the indication information of the transmission direction of the transmission unit on the unlicensed band resource. The configuration information is hereinafter referred to as detection configuration information for short. After acquiring the detection configuration, the terminal learns how to detect the indication information of the transmission direction of the transmission unit on the unlicensed band resource, thereby saving the overhead for the terminal to detect the downlink control signaling.

With the method for determining the direction of the transmission unit provided by the embodiment of the present disclosure, the terminal receives the information corresponding to the transmission direction of the transmission unit within the predefined time window sent by the network side device on one available transmission unit after occupying the unlicensed band resource, which can ensure that when the network side device successfully occupies the channel resource, the information corresponding to the transmission direction of the transmission unit within the predefined time window can be sent to the terminal through this channel resource, so that the terminal can obtain the transmission direction of the transmission unit conveniently and efficiently, avoiding problems of failing to send the transmission direction of the transmission unit within the predefined time window due to a fact that the network side device didn't occupy the channel resource.

In a possible implementation, the information corresponding to the transmission direction of the transmission unit may include indication information of the transmission direction, and the indication information of the transmission direction may include at least one of uplink, downlink, or unknown. FIG. 7 is a flowchart illustrating a method for determining a transmission direction of a transmission unit according to an example embodiment. As illustrated in FIG. 7, in this method, receiving the information corresponding to the transmission direction of the transmission unit within the predefined time window sent by the network side device may include: in block 503, receiving the downlink control signaling sent by the network side device, the indication information of the transmission direction being carried by the downlink control signaling. For example, the terminal may detect the downlink control signaling on the unlicensed band according to the detection configuration information corresponding to the downlink control signaling sent by the network side device, and thus may acquire the transmission direction of the transmission unit within the predefined time window based on the indication information of the transmission direction of the transmission unit carried by the downlink signaling, thereby saving the overhead for the terminal to detect the downlink control signaling.

In a possible implementation, as illustrated in FIG. 7, the method for determining the transmission direction of the transmission unit may further include, in block 504, obtaining first detection configuration information of the downlink control signaling, in which the first detection configuration information includes at least one of the following information: the aggregation degree of the downlink control signaling, the length of the indication information of the transmission direction, the position of the downlink control signaling on the unlicensed band resource, and the number of times to detect the downlink control signaling; and in block 505, detecting the downlink control signaling on the unlicensed band resource according to the first detection configuration information. After the terminal detects the downlink control signaling carrying the indication information of the transmission direction of the transmission unit on the unlicensed band, the terminal may learn the transmission direction of the transmission unit according to the indication information, thereby saving the overhead for the terminal to detect the downlink control signaling. Block 503 may be executed before or after block 504. FIG. 7 only shows a case where block 503 is executed before block 504.

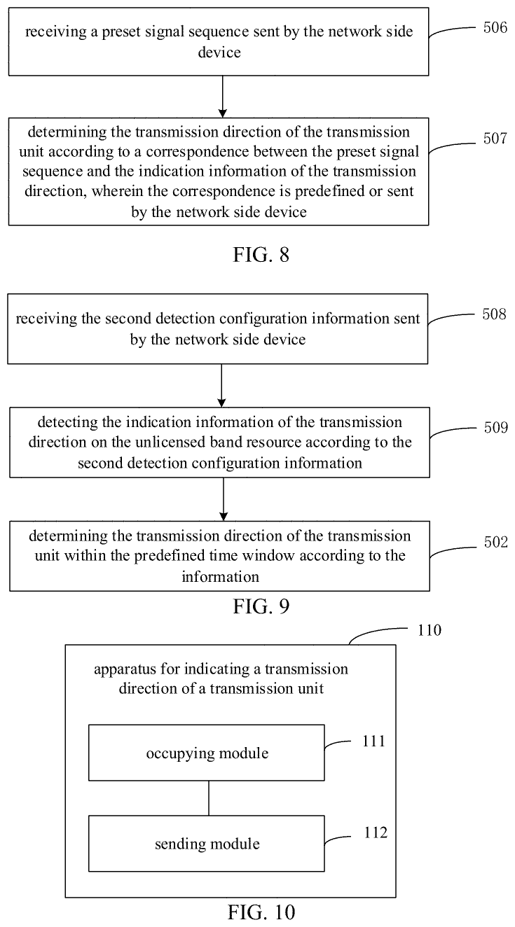

In a possible implementation, the information may include indication information of the transmission direction, and the indication information of the transmission direction may include at least one of uplink, downlink, or unknown. FIG. 8 is a flowchart illustrating a method for determining a transmission direction of a transmission unit according to an example embodiment. As illustrated in FIG. 8, in the method, receiving the information corresponding to transmission direction of the transmission unit within the predefined time window sent by the network side device may include, in block 506, receiving a preset signal sequence sent by the network side device, the indication information of the transmission direction being carried by the preset signal sequence. For example, the network side device and the terminal may agree on the correspondence between the preset signal sequence and the indication information of the transmission direction of the transmission unit in advance, or the network side device may send the correspondence between the preset signal sequence and the indication information of the transmission direction of the transmission unit to the terminal in advance. The terminal may detect the preset signal sequence on the unlicensed band according to the detection configuration information notified by the network side device and acquire the transmission direction of the transmission unit based on the correspondence between the preset signal sequence and the transmission direction of the transmission unit.

In a possible implementation, as illustrated in FIG. 8, determining the transmission direction of the transmission unit within the predefined time window according to the information may include: in block 507, determining the transmission direction of the transmission unit according to the correspondence between the preset signal sequence and the indication information of the transmission direction which is predefined or sent by the network side device. For example, the network side device sends the correspondence between the preset signal sequence and the indication information of the transmission direction of the transmission unit to the terminal in advance. In this correspondence, the signal sequence 0000 indicates uplink, the signal sequence 1111 indicates downlink, and 1100 indicates unknown. When the terminal receives the preset signal sequence 0000, the terminal learns that the transmission direction of the current transmission unit is uplink according to the previously saved correspondence between the preset signal sequence and the transmission direction of the transmission unit.

In a possible implementation, the information may include second detection configuration information. FIG. 9 is a flowchart illustrating a method for determining the transmission direction of the transmission unit according to an example embodiment. As illustrated in FIG. 9, in this method, receiving the information corresponding to the transmission direction of the transmission unit within the predefined time window sent by the network side device may include: in block 508, receiving the second detection configuration information sent by the network-side device, in which the second detection configuration information is configured to instruct the terminal to detect the indication information of the transmission direction on the unlicensed band resource; in block 509, detecting the indication information of the transmission direction on the unlicensed band resource according to the second detection configuration information. The detection configuration information may include information indicating the way the terminal detects the transmission direction of the transmission unit. Based on the detection configuration information, the terminal may detect the indication information of the transmission direction of the transmission unit at the corresponding position on the unlicensed band resource, so as to know the transmission direction of the transmission unit, thereby saving the overhead for the terminal to detect the downlink control signaling.

In a possible implementation, based on the method shown in FIG. 9, when the indication information of the transmission direction is carried by downlink control signaling, the second detection configuration information may include at least one of the following information:

the aggregation level of the downlink control signaling, the information length of the downlink control signaling, the position of the downlink control signaling on the unlicensed band resource, and the number of times to detect the downlink control signaling.

The terminal may use at least one of the above information to detect the downlink control signaling carrying the indication information of the transmission direction of the transmission unit on the unlicensed band, so as to learn the transmission direction of the transmission unit according to the indication information, thereby saving the overhead for the terminal to detect the downlink control signaling.

In a possible implementation, based on the method shown in FIG. 9, when the indication information of the transmission direction is carried by a preset signal sequence, the second detection configuration information includes the period for detecting the preset signal sequence and/or the position of the preset signal sequence in the unlicensed band resource. The terminal may detect the preset signal sequence carrying the indication information of the transmission direction of the transmission unit on the unlicensed band according to the period of the preset signal sequence and/or the position of the preset signal sequence in the unlicensed band resource, so as to acquire the transmission direction of the transmission unit according to the indication information, thereby saving the overhead for the terminal to detect the downlink control signaling.

FIG. 10 is a block diagram illustrating an apparatus for indicating a transmission direction of a transmission unit according to an example embodiment. The apparatus is applied to a network side device. As illustrated in FIG. 10, the apparatus 110 includes an occupying module 111 and a sending module 112.

The occupying module 111 is configured to occupy unlicensed band resource.

The sending module 112 is configured to send information corresponding to the transmission direction of the transmission unit within a time window predefined by the maximum channel occupation time to a terminal on one available transmission unit after the unlicensed band resource is occupied.

In a possible implementation, the information may include indication information of the transmission direction, and the indication information of the transmission direction includes at least one of uplink, downlink, or unknown.

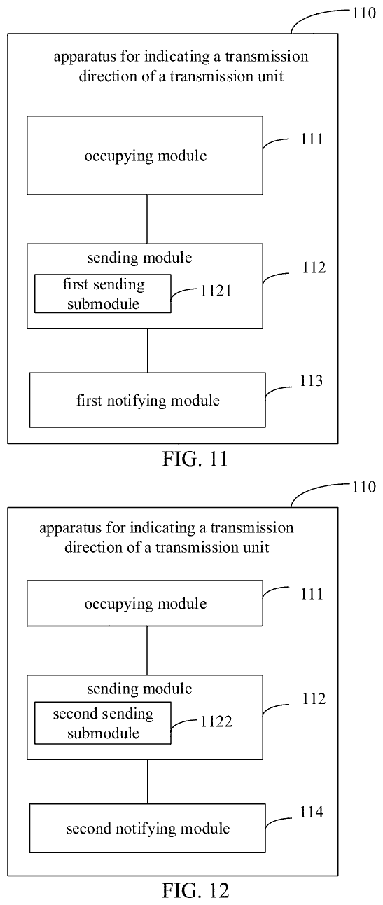

FIG. 11 is a block diagram illustrating an apparatus for indicating a transmission direction of a transmission unit according to an example embodiment. As illustrated in FIG. 11, the sending module 112 of the apparatus may include a first sending submodule 1121. The first sending submodule 1121 is configured to send a downlink control signaling to the terminal on one available transmission unit after the unlicensed band resource is occupied, the indication information of the transmission direction being carried by the downlink control signaling.

In a possible implementation, as illustrated in FIG. 11, the apparatus 110 may further include a first notifying module 113. The first notifying module 113 is configured to send first detection configuration information of the downlink control signaling to the terminal. The first detection configuration information includes at least one of the following information: the aggregation level of the downlink control signaling, the information length of the downlink control signaling, and the position of the downlink control signaling on the unlicensed band resource, and the number of times to detect the downlink control signaling.

In a possible implementation, the information may include indication information of the transmission direction, and the indication information of the transmission direction includes at least a kind of uplink, downlink, or unknown. FIG. 12 is a block diagram illustrating an apparatus for indicating a transmission direction of a transmission unit according to an example embodiment. As illustrated in FIG. 12, in the apparatus, the sending module 112 may include a second sending submodule 1122. The second sending submodule 1122 is configured to send a preset signal sequence on one available transmission unit after the unlicensed band resource is occupied, the indication information of the transmission direction of the transmission unit being carried by the preset signal sequence.

In a possible implementation, as illustrated in FIG. 12, the apparatus may further include a second notifying module 114. The second notifying module 114 is configured to send the correspondence between the preset signal sequence and the indication information of the transmission direction to the terminal.

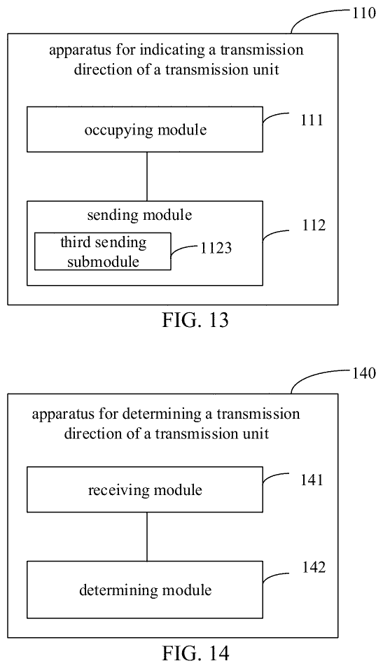

In a possible implementation, the information may include second detection configuration information. FIG. 13 is a block diagram illustrating an apparatus for indicating a transmission direction of a transmission unit according to an example embodiment. As illustrated in FIG. 13, in this apparatus, the sending module 112 may include a third sending submodule 1123. The third sending submodule 1123 is configured to send the second detection configuration information to the terminal on one available transmission unit after the unlicensed band resource is occupied, in which the second detection configuration information is configured to instruct the terminal to detect the indication information of the transmission direction of the transmission unit on the unlicensed band resource.

In a possible implementation, when the indication information of the transmission direction is carried by a downlink control signaling, the second detection configuration information includes at least one of the following information: the aggregation level of the downlink control signaling, the information length of the downlink control signaling, the position of the downlink control signaling on the unlicensed band resource, and the number of times to detect the downlink control signaling.

In a possible implementation, when the indication information of the transmission direction is carried by a preset signal sequence, the second detection configuration information includes the period of detecting the preset signal sequence and/or the position of the preset signal sequence in the unlicensed band resource.

FIG. 14 is a block diagram illustrating an apparatus for determining a transmission direction of a transmission unit according to an example embodiment. The apparatus is applied to a terminal. As illustrated in FIG. 14, the apparatus 140 includes a receiving module 141 and a determining module 142.

The receiving module 141 is configured to receive information corresponding to a transmission direction of a transmission unit within a time window predefined by the maximum channel occupation time sent by a network side device. The information is sent by the network side device on one available transmission unit after the unlicensed band resource is occupied.

The determining module 142 is configured to determine the transmission direction of the transmission unit within the predefined time window according to the information.

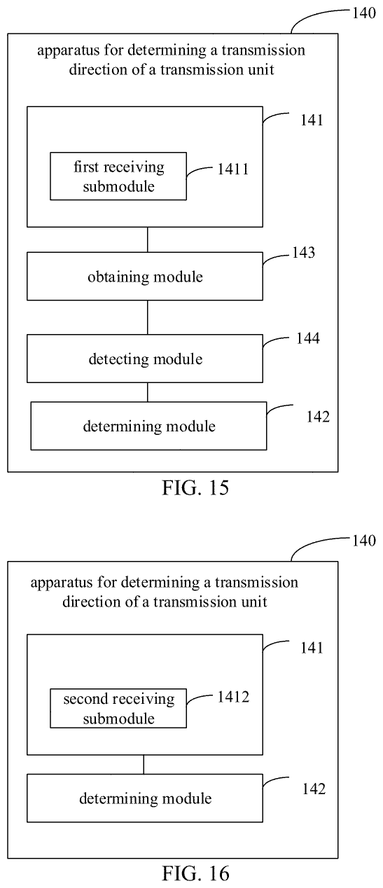

In a possible implementation, the information includes indication information of the transmission direction, and the indication information of the transmission direction includes at least one of uplink, downlink, or unknown. FIG. 15 is a block diagram illustrating an apparatus for determining a transmission direction of a transmission unit according to an example embodiment. As illustrated in FIG. 15, in the apparatus, the receiving module 141 may include a first receiving submodule 1411. The first receiving submodule 1411 is configured to receive a downlink control signaling sent by the network side device, the indication information of the transmission direction being carried by the downlink control signaling.

In a possible implementation, as illustrated in FIG. 15, the apparatus may further include an obtaining module 143 and a detecting module. The obtaining module 143 is configured to obtain the first detection configuration information of the downlink control signaling. The first detection configuration information includes at least one of the following information: the aggregation level of the downlink control signaling, the length of the indication information of the transmission direction, the position of the downlink control signaling on the unlicensed band resource, and the number of times to detect the downlink control signaling. The detecting module 144 is configured to detect the downlink control signaling on the unlicensed band resource according to the first detection configuration information.

In a possible implementation, the information includes indication information of the transmission direction, and the indication information of the transmission direction includes at least one of uplink, downlink, or unknown. FIG. 16 is a block diagram illustrating an apparatus for determining a transmission direction of a transmission unit according to an example embodiment. As illustrated in FIG. 16, the receiving module 141 may include a second receiving submodule 1412. The second receiving submodule 1412 is configured to receive a preset signal sequence sent by the network side device, the indication information of the transmission direction being carried by the preset signal sequence.

In a possible implementation, the determining module may be configured to determine transmission direction of the transmission unit according to the correspondence between the preset signal sequence and the indication information of the transmission direction that is predefined or sent by the network side device.

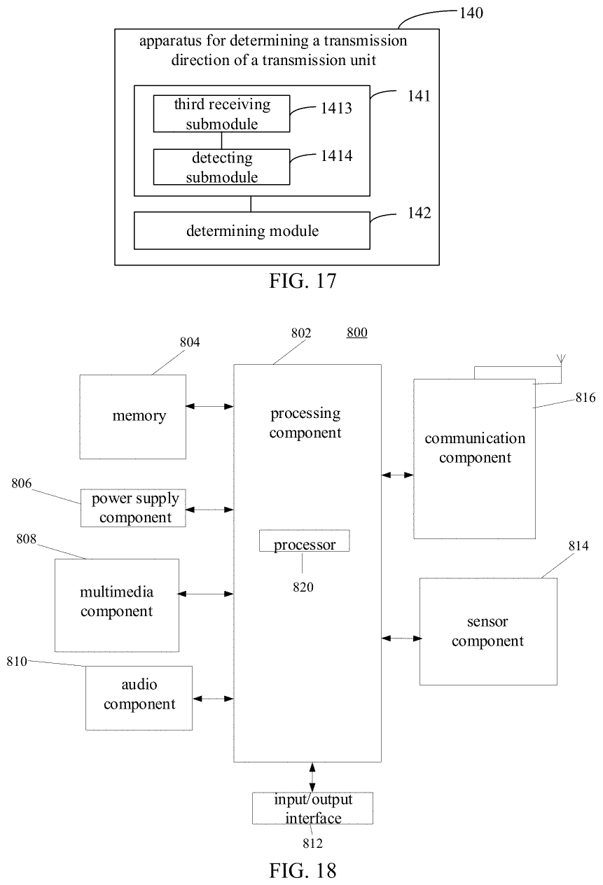

In a possible implementation, the information may include second detection configuration information. FIG. 17 is a block diagram illustrating an apparatus for determining a transmission direction of a transmission unit according to an example embodiment. As illustrated in FIG. 17, the receiving module 141 may include a third receiving submodule 1413 and a detecting submodule 1414.

The third receiving submodule 1413 is configured to receive the second detection configuration information sent by the network side device, in which the second detection configuration information is configured to instruct the terminal to detect the indication information of the transmission direction on unlicensed band resource.

The detecting submodule 1414 is configured to detect the indication information of the transmission direction on the unlicensed band resource according to the second detection configuration information.

In a possible implementation, when the indication information of the transmission direction is carried by the downlink control signaling, the second detection configuration information includes at least one of the following information:

the aggregation level of the downlink control signaling, the information length of the downlink control signaling, the position of downlink control signaling in the unlicensed band resource and the number of times to detect the downlink control signaling.

In a possible implementation, when the indication information of the transmission direction is carried by a preset signal sequence, the second detection configuration information includes the period of detecting the preset signal sequence and/or the position of the preset signal sequence on the unlicensed band resource.

Regarding the apparatus in the above embodiments, the specific manners in which each module performs operations has been described in detail in the embodiments of the method, and will not be elaborated here.

FIG. 18 is a block diagram illustrating a device for determining a transmission direction of a transmission unit according to an example embodiment. For example, the device 800 may be a mobile phone, a computer, a digital broadcasting terminal, a messaging device, a game console, a tablet device, a medical device, a fitness device, a personal digital assistant, etc. Referring to FIG. 18, the device 800 may include one or more of the following components: a processing component 802, a memory 804, a component 806, a multimedia component 808, an audio component 810, an input/output (I/O) interface 812, a sensor component 814, and a communication component 816. The processing component 802 generally controls the overall operations of the device 800, such as operations associated with display, telephone calls, data communications, camera operations, and recording operations.

The processing component 802 may include one or more processors 820 to execute instructions to implement all or part of the steps of the foregoing method. In addition, the processing component 802 may include one or more modules to facilitate the interaction between the processing component 802 and other components. For example, the processing component 802 may include a multimedia module to facilitate the interaction between the multimedia component 808 and the processing component 802.

The memory 804 is configured to store various types of data to support the operation of the device 800. Examples of such data include instructions for any application or method executed by on the device 800, contact data, phone book data, messages, pictures, videos, etc. The memory 804 can be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk. The power supply component 806 provides power to various components of the device 800. The power supply component 806 may include a power management system, one or more power supplies, and other components associated with the generation, management, and distribution of power for the device 800.

The multimedia component 808 includes a screen that provides an output interface between the device 800 and a user. In some embodiments, the screen may include a liquid crystal display (LCD) and a touch panel (TP). In some embodiments, an organic light-emitting diode (OLED) display may be employed.

If the screen includes a touch panel, the screen may be implemented as a touch screen to receive input signals from the user. The touch panel includes one or more touch sensors to sense touch, sliding, and gestures on the touch panel. The touch sensor can not only sense the boundary of a touch or slide action, but also detect the duration and pressure related to the touch or slide operation. In some embodiments, the multimedia component 808 includes a front camera and/or a rear camera. When the device 800 is in an operation mode, such as a shooting mode or a video mode, the front camera and/or the rear camera can receive external multimedia data. Each front camera and rear camera can be a fixed optical lens system or have a focal length and optical zoom capabilities.

The audio component 810 is configured to output and/or input audio signals. For example, the audio component 810 includes a microphone (MIC). When the device 800 is in an operating mode, such as a call mode, a recording mode, and a voice recognition mode, the microphone is configured to receive external audio signals. The received audio signal may be further stored in the memory 804 or transmitted via the communication component 816. In some embodiments, the audio component 810 further includes a speaker for outputting audio signals. The I/O interface 812 provides an interface between the processing component 802 and the peripheral interface module. The peripheral interface module may be a keyboard, a click wheel, a button, and so on. These buttons may include but are not limited to: a home button, a volume button, a start button, and a lock button. The sensor component 814 includes one or more sensors for providing the device 800 with various aspects of state assessment.

For example, the sensor component 814 can detect the on/off state of the device 800 and the relative positioning of components, such as the display and keypad of the device 800. The sensor component 814 can also detect the position change of the device 800 or a component of the device 800, whether a user contacts with the device 800, the orientation or acceleration/deceleration of the device 800, and the temperature change of the device 800. The sensor component 814 may include a proximity sensor configured to detect the presence of nearby objects when there is no physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor. The communication component 816 is configured to facilitate wired or wireless communication between the device 800 and other devices.

The device 800 can access a wireless network based on a communication standard, such as Wi-Fi, 2G, 3G, 4G, 5G, or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to facilitate short-range communication. For example, the NFC module can be implemented based on a radio frequency identification (RFID) technology, an infrared data association (IrDA) technology, an ultra-wideband (UWB) technology, a Bluetooth (BT) technology and other technologies.

In an exemplary embodiment, the device 800 may be implemented by one or more Application Specific Integrated Circuits (ASIC), Digital Signal Processors (DSP), Digital Signal Processing Devices (DSPD), Programmable Logic Devices (PLD), Field-Programmable Gate Array (FPGA), controller, micro-controller, microprocessor, or other electronic components, for performing the above methods.

In an exemplary embodiment, there is also provided a non-transitory computer-readable storage medium including instructions, such as the memory 804 including instructions, which may be executed by the processor 820 of the device 800 to implement the above methods. For example, the non-transitory computer-readable storage medium may be a Read-Only Memory (ROM), a Random-Access Memory (RAM), a CD-ROM, a magnetic tape, a floppy disk, an optical data, a storage device, etc.

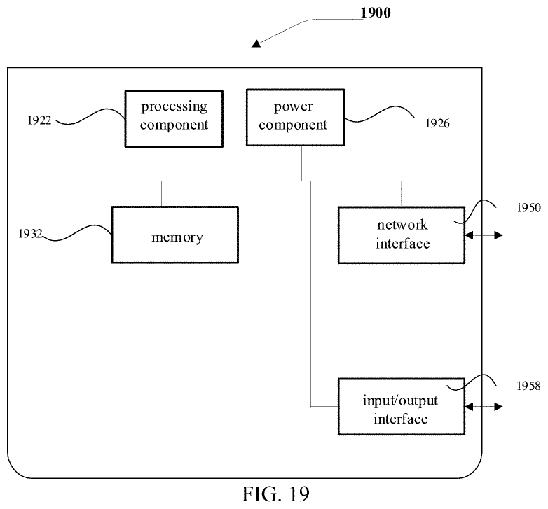

FIG. 19 is a block diagram illustrating a device for determining a transmission direction of a transmission unit according to an example embodiment. For example, the device 1900 may be provided as a server. Referring to the FIG. 19, the device 1900 includes a processing component 1922, which further includes one or more processors, and memory resources represented by the memory 1932 for storing instructions executable by the processing component 1922, such as application programs. The applications stored in the memory 1932 may include one or more modules, in which each corresponds to a set of instructions. In addition, the processing component 1922 is configured to execute instructions to implement the above method for determining a transmission direction of a transmission unit. The device 1900 may further include a power component 1926 configured to perform power management of the device 1900, a wired or wireless network interface 1950 configured to connect the device 1900 to the network, and an input/output (I/O) interface 1958.

The device 1900 can operate based on an operating system stored in the memory 1932, such as WINDOWS SERVER™, MAC OS X™, UNIX™ LINUX™, FREEBSD™. In an exemplary embodiment, there is also provided a non-transitory computer-readable storage medium including instructions, such as the memory 1932 including instructions, which can be executed by the processing component 1922 of the device 1900 to complete the above method. For example, the non-transitory computer-readable storage medium may be a ROM, a Random-Access Memory (RAM), a CD-ROM, a magnetic tape, a floppy disk, an optical data storage device, etc.

The various device components, modules, circuits, portions, blocks, or units may have modular configurations, or are composed of discrete components, but nonetheless can be referred to as “modules,” components, or “portions” in general. In other words, the “components,” “modules,” circuits,” “portions,” “blocks,” or “units” referred to herein may or may not be in modular forms, and these phrases may be interchangeably used.

In the present disclosure, it is to be understood that the terms “lower,” “upper,” “center,” “longitudinal,” “transverse,” “length,” “width,” “thickness,” “upper,” “lower,” “front,” “back,” “left,” “right,” “vertical,” “horizontal,” “top,” “bottom,” “inside,” “outside,” “clockwise,” “counterclockwise,” “axial,” “radial,” “circumferential,” “column,” “row,” and other orientation or positional relationships are based on example orientations illustrated in the drawings, and are merely for the convenience of the description of some embodiments, rather than indicating or implying the device or component being constructed and operated in a particular orientation. Therefore, these terms are not to be construed as limiting the scope of the present disclosure.

Moreover, the terms “first” and “second” are used for descriptive purposes only and are not to be construed as indicating or implying a relative importance or implicitly indicating the number of technical features indicated. Thus, elements referred to as “first” and “second” may include one or more of the features either explicitly or implicitly. In the description of the present disclosure, “a plurality” indicates two or more unless specifically defined otherwise.

In the present disclosure, the terms “installed,” “connected,” “coupled,” “fixed” and the like shall be understood broadly, and may be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms in the present disclosure can be understood by those of ordinary skill in the art on a case-by-case basis.

In the present disclosure, a first element being “on,” “over,” or “below” a second element may indicate direct contact between the first and second elements, without contact, or indirect through an intermediate medium, unless otherwise explicitly stated and defined.

Moreover, a first element being “above,” “over,” or “at an upper surface of” a second element may indicate that the first element is directly above the second element, or merely that the first element is at a level higher than the second element. The first element “below,” “underneath,” or “at a lower surface of” the second element may indicate that the first element is directly below the second element, or merely that the first element is at a level lower than the second feature. The first and second elements may or may not be in contact with each other.

In the description of the present disclosure, the terms “one embodiment,” “some embodiments,” “example,” “specific example,” or “some examples,” and the like may indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described may be combined in a suitable manner in any one or more embodiments or examples. In addition, various embodiments or examples described in the specification, as well as features of various embodiments or examples, may be combined and reorganized.

In some embodiments, the control and/or interface software or app can be provided in a form of a non-transitory computer-readable storage medium having instructions stored thereon is further provided. For example, the non-transitory computer-readable storage medium may be a Read-Only Memory (ROM), a Random-Access Memory (RAM), a Compact Disc Read-Only Memory (CD-ROM), a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more modules of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium may be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures. For example, the devices can be controlled remotely through the Internet, on a smart phone, a tablet computer or other types of computers, with a web-based graphic user interface (GUI).

A computer program (also known as a program, software, software application, app, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a mark-up language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode) display, other flexible configuration, or any other monitor for displaying information to the user and a keyboard, a pointing device, e.g., a mouse, trackball, etc., or a touch screen, touch pad, etc., by which the user can provide input to the computer.

Other types of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In an example, a user can speak commands to the audio processing device, to perform various operations.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombinations.

Moreover, although features may be described above as acting in certain combinations and even initially claimed as such, one or more features from a claimed combination can in some cases be excised from the combination, and the claimed combination may be directed to a subcombination or variations of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

What is claimed is:

1. A method for indicating a transmission direction of a transmission unit, applied to a network side device, comprising:
occupying unlicensed band resource; and
sending information corresponding to a transmission direction of a transmission unit within a predefined time window to a terminal on one available transmission unit after occupying the unlicensed band resource.

2. The method of claim 1, wherein the information comprises indication information of the transmission direction, wherein the indication information of the transmission direction comprises at least one of uplink, downlink, or unknown, and wherein said sending the information corresponding to the transmission direction of the transmission unit within the predefined time window to the terminal on one available transmission unit after occupying the unlicensed band resource comprises:
sending a downlink control signaling to the terminal on one available transmission unit after occupying the unlicensed band resource, the indication information of the transmission direction being carried by the downlink control signaling.

3. The method of claim 2, further comprising:
sending first detection configuration information of the downlink control signaling to the terminal, wherein the first detection configuration information comprises at least one of following information:
an aggregation level of the downlink control signaling, an information length of the downlink control signaling, a position of the downlink control signaling on the unlicensed band resource, and a number of times to detect the downlink control signaling.

4. The method of claim 1, wherein the information comprises indication information of the transmission direction, wherein the indication information of the transmission direction comprises at least one of uplink, downlink, or unknown, and wherein said sending information corresponding to the transmission direction of the transmission unit within the predefined time window to the terminal on one available transmission unit after occupying the unlicensed band resource comprises:
sending a preset signal sequence on one available transmission unit after occupying the unlicensed band resource;
the indication information of the transmission direction of the transmission unit being carried by the preset signal sequence.

5. The method of claim 4, further comprising:
sending a correspondence between the preset signal sequence and the indication information of the transmission direction to the terminal.

6. The method of claim 1, wherein the information comprises second detection configuration information, and said sending the information corresponding to the transmission direction of the transmission unit within the predefined time window to the terminal on one available transmission unit after occupying the unlicensed band resource comprises:
sending the second detection configuration information to the terminal on one available transmission unit after occupying the unlicensed band resource, wherein the second detection configuration information is configured to instruct the terminal to detect the indication information of the transmission direction of the transmission unit on the unlicensed band resource.

7. The method of claim 6, wherein the indication information of the transmission direction is carried by a downlink control signaling, and the second detection configuration information comprises at least one of following information:
an aggregation level of the downlink control signaling, an information length of the downlink control signaling, a position of the downlink control signaling on the unlicensed band resource, and a number of times to detect the downlink control signaling.

8. The method of claim 6, wherein the indication information of the transmission direction is carried by a preset signal sequence, and the second detection configuration information comprises a period of detecting the preset signal sequence and/or a position of the preset signal sequence in the unlicensed band resource.

9. A method for determining a transmission direction of a transmission unit, applied to a terminal, comprising:
receiving information corresponding to a transmission direction of a transmission unit within a predefined time window sent by a network side device, wherein the information is sent by the network side device on one available transmission unit after occupying unlicensed band resource;
determining the transmission direction of the transmission unit within the predefined time window according to the information.

10. The method of claim 9, wherein the information comprises indication information of the transmission direction, wherein the indication information of the transmission direction comprises at least one of uplink, downlink, or unknown, and said receiving the information corresponding to the transmission direction of the transmission unit within the predefined time window sent by the network side device comprises:
receiving a downlink control signaling sent by the network side device, the indication information of the transmission direction being carried by the downlink control signaling.

11. The method of claim 10, further comprising:
obtaining first detection configuration information of the downlink control signaling, wherein the first detection configuration information comprises at least one of an aggregation level of the downlink control signaling, a length of the indication information of the transmission direction, a position of the downlink control signaling on the unlicensed band resource, and a number of times to detect the downlink control signaling; and
detecting the downlink control signaling on the unlicensed band resource according to the first detection configuration information.

12. The method of claim 9, wherein the information comprises indication information of the transmission direction, wherein the indication information of the transmission direction comprises at least one of uplink, downlink, or unknown, and said receiving the information corresponding to the transmission direction of the transmission unit within the predefined time window sent by the network side device comprises:
receiving a preset signal sequence sent by the network side device, the indication information of the transmission direction being carried by the preset signal sequence.

13. The method of claim 12, wherein said determining the transmission direction of the transmission unit within the predefined time window according to the information, comprises:
determining the transmission direction of the transmission unit according to a correspondence between the preset signal sequence and the indication information of the transmission direction, wherein the correspondence is predefined or sent by the network side device.

14. The method of claim 9, wherein the information comprises second detection configuration information, and said receiving the information corresponding to the transmission direction of the transmission unit within the predefined time window sent by the network side device comprises:
receiving the second detection configuration information sent by the network side device, wherein the second detection configuration information is configured to instruct the terminal to detect the indication information of the transmission direction on the unlicensed band resource;
detecting the indication information of the transmission direction on the unlicensed band resource according to the second detection configuration information.

15. The method of claim 14, wherein the indication information of the transmission direction is carried by a downlink control signaling, and the second detection configuration information comprises at least one of following information:
an aggregation level of the downlink control signaling, an information length of the downlink control signaling, a position of the downlink control signaling on the unlicensed band resource, and a number of times to detect the downlink control signaling.

16. The method of claim 14, wherein the indication information of the transmission direction is carried by a preset signal sequence, and the second detection configuration information comprises a period of detecting the preset signal sequence and/or a position of the preset signal sequence in the unlicensed band resource.

17. A device implementing the method for indicating a transmission direction of a transmission unit according to claim 1, comprising:
a processor;
memory configured to store instructions executable by the processor;
wherein the processor is configured to perform steps of the method.

18. The device of claim 17, wherein the device is configured to ensure that when the network side device successfully occupies the channel resource, the information corresponding to the transmission direction of the transmission unit within the predefined time window is sent to the terminal through the channel resource, thereby facilitating the terminal obtaining the transmission direction of the transmission unit efficiently.

19. The device of claim 18, wherein the device is further configured to avoid a situation of failing to send the transmission direction of the transmission unit within the predefined time window resulting from that the network side device does not occupy the channel resource.

20. A device for determining a transmission direction of a transmission unit, comprising:
a processor;
memory configured to store instructions executable by the processor;
wherein the processor is configured to:
receive information corresponding to a transmission direction of a transmission unit within a predefined time window sent by a network side device, wherein the information is sent by the network side device on one available transmission unit after occupying unlicensed band resource; and
determine the transmission direction of the transmission unit within the predefined time window according to the information.
